(19) United States
(12) Patent Application Publication
(10) Pub. No.: US 2026/0069012 A1
(43) Pub. Date: Mar. 12, 2026

(54) LED Intelligent Bag or Luggage Controlled by the App of a Mobile Device

(71) Applicant: Zhijian Li, Fuzhou (CN)

(72) Inventor: Zhijian Li, Fuzhou (CN)

(21) Appl. No.: 19/323,245

(22) Filed: Sep. 9, 2025

Related U.S. Application Data
(60) Provisional application No. 63/692,673, filed on Sep. 9, 2024.

(51) Int. Cl. A45C 15/06; A45C 5/03; A45C 5/14; A45F 3/00; A45F 3/04; F21V 23/00; F21V 23/04; F21Y 103/10; F21Y 115/10

(52) U.S. Cl. CPC A45C 15/06; A45C 5/03; A45C 5/14; A45F 3/04; F21V 23/003; F21V 23/0435; A45F 2003/003; F21Y 2103/10; F21Y 2115/10

(57) ABSTRACT

A luggage item such as a backpack or suitcase such as a rolling suitcase or trolley bag or other luggage item includes a body with at least one outer surface and at least one inner surface; at least one light emitting diode (LED) disposed on a portion of the body; and electronics configured to connect the at least one LED to an associated mobile device to allow the associated mobile device to control operation of the at least one LED.

### CROSS-REFERENCE TO RELATED APPLICATIONS

This application claims priority from and benefit of the filing date of U.S. provisional application Ser. No. 63/692,673 filed Sep. 9, 2024, and the entire disclosure of said provisional application is hereby expressly incorporated by reference into the present specification.

### FIELD

The present disclosure relates to a luggage item such as a backpack or other bag or piece of luggage (e.g., a suitcase such as a rolling or trolley suitcase) that includes a light strip system that can be remotely controlled by a mobile device, which improves the convenience of use and personalized degree of the item.

### BACKGROUND

Items that people use to carry things, such as backpacks, other luggage, and suitcases, can include lights to help the owner of the item identify their item amongst a group of items (e.g., at a baggage claim carousel in an airport). However, most existing light systems are manually controlled, which cannot easily meet the personalized needs of users for luggage lighting in different environments. Furthermore, such existing light systems have a single function and are similar in appearance and form, which prevents users from quickly locating their items.

The following specification discloses improvements to address these problems and others and to provide better overall results.

### SUMMARY

According to one example, the present development relates to an item including a body with at least one outer surface and at least one inner surface; at least one light emitting diode (LED) disposed on a portion of the body; and electronics configured to connect the at least one LED to an associated mobile device to allow the associated mobile device to control operation of the at least one LED.

According to another example, the present development relates to an item including a body with at least one outer surface and at least one inner surface; a plurality of light emitting diodes (LEDs) disposed on a LED strip attached to a portion of the body; and electronics configured to connect the LEDs to an associated mobile device to allow the associated mobile device to control operation of the LEDs.

According to another example, the present development relates to an item including a body with at least one outer surface and at least one inner surface; at least one light emitting diode (LED) disposed on a portion of the body; and electronics configured to connect the at least one LED to an associated mobile device to allow the associated mobile device to control operation of the at least one LED, the electronics including a Bluetooth module configured to connect the LEDs to the associated mobile device; a microcontroller unit (MCU) module connected to the Bluetooth module, the MCU module configured to control operation of the LEDs; and a mobile application installed on the associated mobile device, the mobile application being connected to the MCU module via the Bluetooth module.

According to one example, the luggage item can be a wearable backpack or other wearable bag or a piece of luggage, e.g., a suitcase such as a rolling or trolley suitcase.

### BRIEF DESCRIPTION OF THE DRAWINGS

FIGS. 1A and 1B show a luggage item such as a bag (shown as a backpack) provided in accordance with an embodiment of the present development.

FIGS. 2A-2D show a luggage item such as a rolling suitcase or trolley bag provided in accordance with another embodiment of the present development.

FIGS. 3A-3D show another luggage item provided in accordance with a further embodiment of the present development.

FIGS. 4A-4D show a further embodiment of a luggage item provided in accordance with the present development.

### DETAILED DESCRIPTION

The present development relates to a bag such as a wearable backpack or other wearable bag or piece of luggage (e.g., a suitcase such as a rolling or trolley suitcase) that includes at least one light-emitting diode (LED) light source such as an LED light strip that can be visible on the exterior of the bag when illuminated and that is powered by a battery contained within the bag and that can be controlled in terms of on, off, brightness, color, flashing, solid, and/or other characteristics by a mobile phone app that is operatively connected to the LED light source by a Bluetooth or other wireless connection.

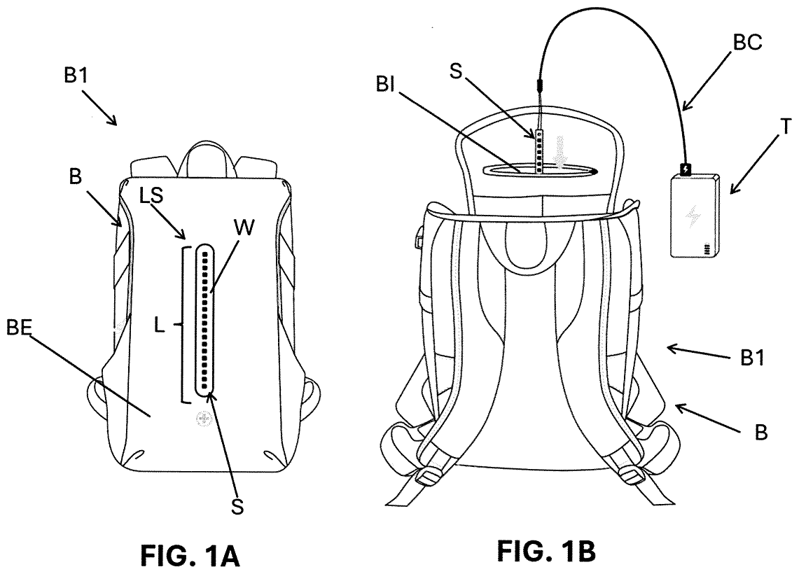

FIGS. 1A and 1B show an item, such as a bag B1 (shown as a backpack), that includes a body B and an LED light source LS such as an LED light strip S including one or multiple LEDs L disposed on the body B. As shown in FIG. 1A, the light source LS is connected to the body B of the bag B1 such that the one or more LEDs L are visible on the outside or exterior surface BE of the bag B1 when the LEDs are illuminated. In the illustrated example, the exterior BE of the bag B1 includes a slot or window W through which the LEDs L can be visible when illuminated (and also when not illuminated in some examples). The window W can be transparent film or material or can be provided by an opening or a translucent material. In another example, as shown in FIG. 1B the LED light strip S can be positioned within an interior surface B1 of the body B and positioned behind the window W so that the LED light strip S is visible through the window W. As best shown in FIG. 1B, the bag B1 includes a battery T that is contained in a pocket or other location inside or otherwise connected to the bag B1 and the battery T is connected by a battery cable BC to the LED light source LS to provide electrical power thereto. The battery T can be replaceable and/or rechargeable by a wired or wireless battery charging device.

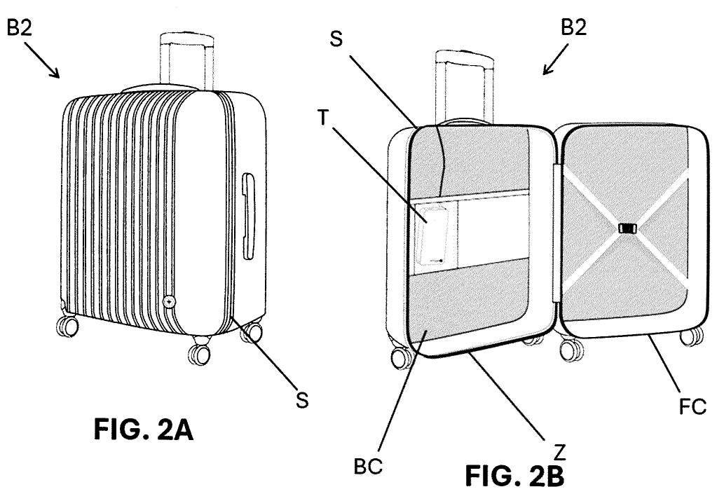

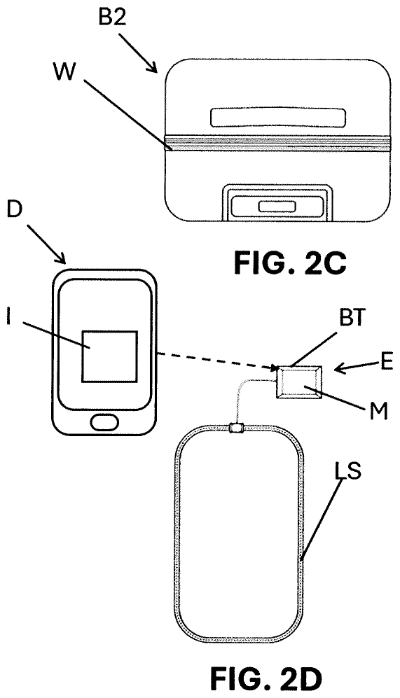

FIGS. 2A-2D are similar to FIGS. 1A-1B but show the luggage item as a rolling suitcase bag B2 with wheels and a handle instead of as a wearable backpack B1. The bag B2 includes an LED light source LS provided as a light strip S that extends at least partially or completely around a seam of the bag B2 such as along the full length of a zipper Z that joins a front cover FC to a rear cover RC. The light source LS is visible external to the bag B2 when illuminated via the window W. The bag B2 includes a battery T that is contained in a pocket or other location inside or otherwise connected to the bag B2 and the battery T is connected by a battery cable BC to the LED light sources LS to provide electrical power thereto. The battery T can be replaceable and/or rechargeable by a wired or wireless battery charging device. FIG. 2D also shows the light source LS being connected to electronics module E that includes a Bluetooth module BT and at least one electronic processor micro controller unit (“controller” or “MCU”) M that controls operation of each LED light source LS, as described in more detail below.

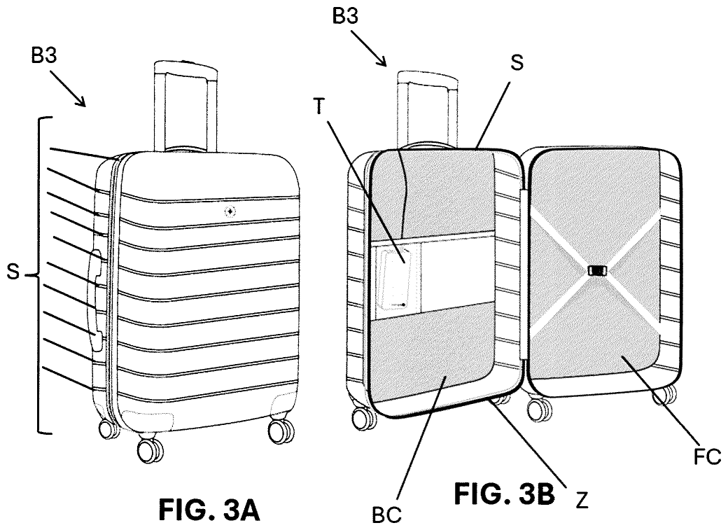

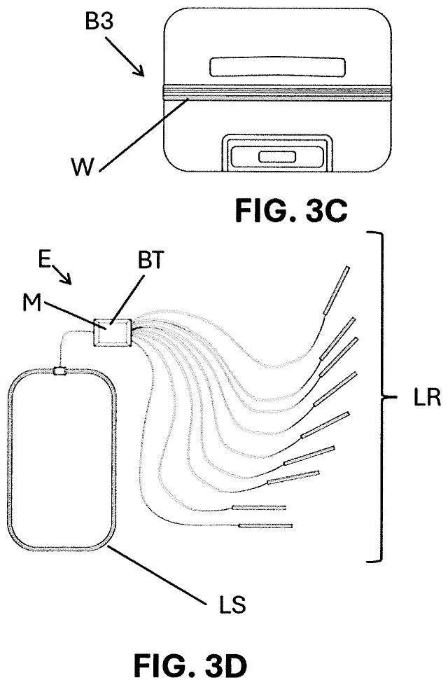

FIGS. 3A-3D are similar to FIGS. 2A-2D and also show the item as a rolling suitcase bag B3 with wheels and a handle instead of as a backpack B1. In addition, and/or as an alternative to the light source LS shown in FIGS. 2A-2D adjacent and following along the zipper Z, the bag B3 further includes multiple LED light sources LS arranged in parallel relation to each other and visible on the front and/or rear covers FC, RC of the bag B3. In the illustrated example, the light sources LS are arranged such that the bag B3 includes a plurality of axially spaced apart light rings LR each of which extend across both the front and rear covers FC, RC. Each light source LS is visible external to the bag B3 when illuminated such as through a respective window W in the front and rear covers FC, RC. The bag B3 includes a battery T that is contained in a pocket or other location inside or otherwise connected to the bag B3 and the battery T is connected by a battery cable BC to the LED light sources LS to provide electrical power thereto. The battery T can be replaceable and/or rechargeable by a wired or wireless battery charging device. FIG. 3D also shows the light source LS being connected to the electronics module E that includes the Bluetooth module BT and the MCU M that controls operation of each light ring LR.

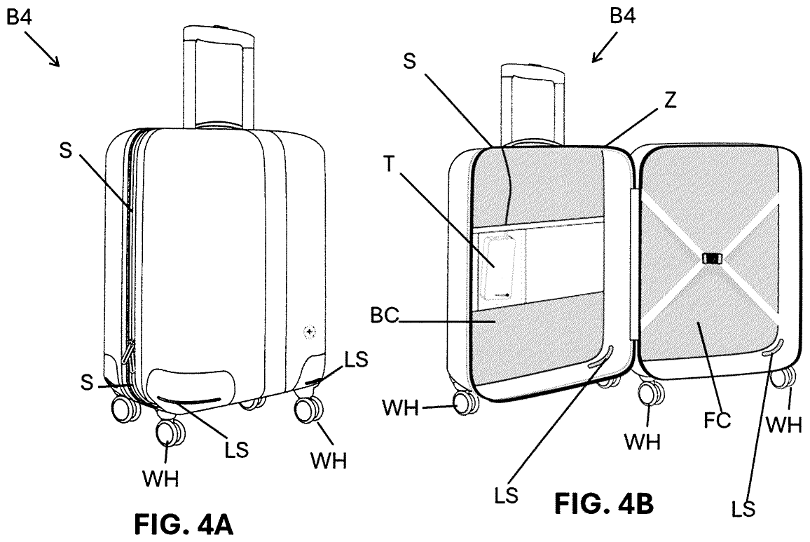

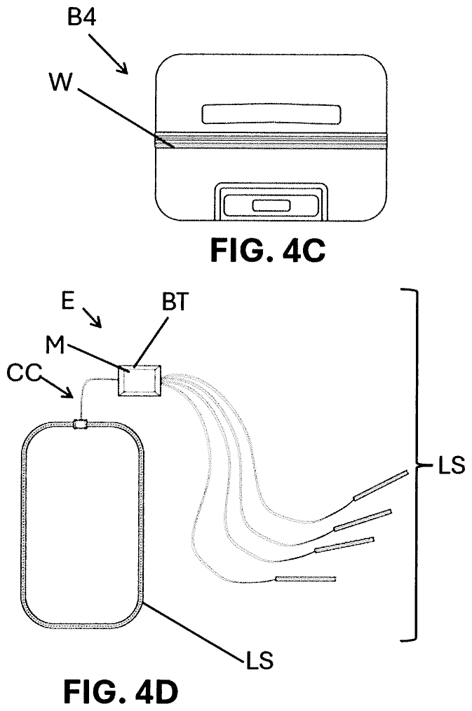

FIGS. 4A-4D are similar to FIGS. 3A-3D and also show the item as a rolling suitcase bag B4 with wheels and a handle instead of as a backpack B1. In addition, and/or as an alternative to the light source LS shown in FIGS. 3A-3D adjacent and following along the zipper Z, the bag B4 further includes LED light sources LS located adjacent at least one corner of at least one of the front and rear covers FC, RC. In the illustrated example, the front cover FC includes two LED light sources LS arranged adjacent at least two lower corners CF adjacent the wheels W, and the rear cover RC includes two LED light sources LS arranged adjacent at least two lower corners CR adjacent the wheels WH so that the bag B4 includes four LED light sources at the respective corners CF, CR and can optionally also include the LED light source LS that follows along the zipper Z. The bag B4 includes a battery T that is contained in a pocket or other location inside or otherwise connected to the bag B4 and the battery T is connected by a battery cable BC to the LED light sources LS to provide electrical power thereto. The battery T can be replaceable and/or rechargeable by a wired or wireless battery charging device. FIG. 3D also shows the light source LS being connected to the electronics module E that includes the Bluetooth module BT and the MCU M that controls operation of each light sources LS.

Each item B1-B4, also includes the at least one electronic processor micro controller unit (“controller” or “MCU”) M that controls operation of each LED light source LS in terms of its on or off state, brightness, solid or flashing pattern, color, and/or other illumination characteristics. The controller M is powered by the battery T by way of the same or a different battery cable BC a device's operations. The controller M can be physically connected to and/or integrated into one of the LED light sources LS or can be separate from the LED light source LS and operatively connected to each LED light source LS by a control cable CC (FIG. 4D) that can also carry electrical power from the controller M supplied by the battery T.

As shown in FIG. 2D, a mobile device D such as a mobile phone is operatively connected to the controller M by a wireless connection such as the Bluetooth module BT or wifi or other wireless radio frequency connection. The mobile device D runs a software program or “app” that provides instructions to the controller M and that can optionally also receive feedback signals from the controller M that provide information to the app running on the device D as to the state of the LED light source(s) LS being controlled via the mobile device D. A user can use the mobile device D to run the app send wireless control signals from the mobile device D to the controller M to cause the controller M to control the LED light sources LS in terms of at least one of or all of: on or off state of the LEDs L, brightness of the LEDs L, solid or flashing pattern of the LEDs L, color of the LEDs L, and/or other illumination characteristics of the LEDs L. For example, when the user opens the app (which is downloaded and installed onto the mobile device D), the app provides an interface I on a screen of the mobile device D. The user can provide inputs (i.e., finger taps or scrolls) on the interface to control operation of the LED light sources LS. For example, a user can select, via the interface, a color of the LED light sources LS (i.e., the LED light sources LS can all be the same color, or one or more of the LED light sources can be different colors), a brightness of LED light sources LS (i.e., the LED light sources LS can all have the same brightness, or one or more of the LED light sources can have different brightness levels), turning on or off the LED light sources LS, a length of time that the LED light sources LS are turned on, whether or not the LED light sources LS are blinking or not, and so forth.

The bag B1-B4 can optionally include at least one manual power on/off switch, disposed on the light strip LS, by which a user can manually activate or deactivate the LED light source(s) S of the bag, without using the app of the mobile device D and/or to override control of the app of the mobile device D.

The present disclosure, through one or more of its various aspects, embodiments and/or specific features or sub-components, is thus intended to bring out one or more of the advantages as specifically noted herein. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

1. A luggage item, comprising:
a body with at least one outer surface and at least one inner surface;
at least one light emitting diode (LED) disposed on a portion of the body; and
electronics configured to connect the at least one LED to an associated mobile device to allow the associated mobile device to control operation of the at least one LED.

2. The luggage item of claim 1, wherein the at least one LED is disposed on a portion of the at least one outer surface of the body.

3. The luggage item of claim 1, wherein the at least one LED is embedded within a portion of the at least one inner surface of the body and visible through the at least one outer surface of the body.

4. The luggage item of claim 1, wherein the at least one LED light comprises a plurality of LEDs disposed on a strip, at least one LED light source and a power on/off button being disposed on the strip, and wherein the item comprises one of: a wearable backpack, a wearable bag, a piece of luggage, a rolling trolley suitcase.

5. The luggage item of claim 4, where the LEDs are arranged parallel to each other relative to the strip.

6. The luggage item of claim 4, wherein the strip extends around at least a portion of the body along a length of a zipper that joins a front cover to a rear cover of the body.

7. The luggage item of claim 6, further comprising multiple light sources disposed on the strip arranged in parallel relation to each other and visible on at least one of the front and rear covers.

8. The luggage item of claim 7, wherein the multiple light sources are arranged on the body as a plurality of axially spaced apart light rings, each of which extend across both the front and rear covers.

9. The luggage item of claim 7, wherein the multiple light sources include at least one light source disposed in a corner of one of the front and rear covers.

10. The luggage item of claim 1, wherein the electronics include:
a Bluetooth module configured to connect the at least one LED to the associated mobile device;
a microcontroller unit (MCU) module connected to the Bluetooth module, the MCU module configured to control operation of the at least one LED; and
a mobile application installed on the associated mobile device, the mobile application being connected to the MCU module via the Bluetooth module.

11. The luggage item of claim 10, wherein the MCU module is configured to control operation of the at least one LED by at least one of:
turning on the at least one LED;
turning off the at least one LED;
changing a brightness of the at least one LED;
changing a color of the at least one LED;
changing a mode of the a least one LED from at least one of a long light, a running light, and a flashing light.

12. The luggage item of claim 1, further comprising a battery connected to the at least one LED, the battery being disposed in a battery storage space in the inner surface of body.

13. The luggage item of claim 1, further comprising at least one of:
a transparent material disposed over the at least one LED; and
an opening adjacent the at least one LED.

14. A wearable or rollable luggage item, comprising:
a body with at least one outer surface and at least one inner surface;
a plurality of light emitting diodes (LEDs) disposed on a LED strip attached to a portion of the body; and
electronics configured to connect the LEDs to an associated mobile device to allow the associated mobile device to control operation of the LEDs.

15. The wearable or rollable luggage item of claim 14, wherein the LED strip is disposed on a portion of the at least one outer surface of the body.

16. The wearable or rollable luggage item of claim 14, wherein the LED strip is embedded within a portion of the at least one inner surface of the body and visible through the at least one outer surface of the body.

17. The wearable or rollable luggage item of claim 14, configured as one of: a wearable backpack, a wearable bag, a piece of luggage, a rolling trolley suitcase, wherein the electronics include:
a Bluetooth module configured to connect the LEDs to the associated mobile device;
a microcontroller unit (MCU) module connected to the Bluetooth module, the MCU module configured to control operation of the LEDs; and
a mobile application installed on the associated mobile device, the mobile application being connected to the MCU module via the Bluetooth module.

18. The wearable or rollable luggage item of claim 17, wherein the MCU module is configured to control operation of the LEDs by at least one of:
turning on the LEDs;
turning off the LEDs;
changing a brightness of the LEDs;
changing a color of the LEDs;
changing a mode of the LEDs from at least one of a long light, a running light, and a flashing light.

19. A luggage or wearable backpack item, comprising:
a body with at least one outer surface and at least one inner surface;
at least one light emitting diode (LED) disposed on a portion of the body; and
electronics configured to connect the at least one LED to an associated mobile device to allow the associated mobile device to control operation of the at least one LED, the electronics including:
a Bluetooth module configured to connect the LEDs to the associated mobile device;
a microcontroller unit (MCU) module connected to the Bluetooth module, the MCU module configured to control operation of the LEDs; and
a mobile application installed on the associated mobile device, the mobile application being connected to the MCU module via the Bluetooth module.

20. The luggage or wearable backpack item of claim 19, wherein the at least one LED light comprises a plurality of light emitting diodes (LEDs) disposed on a LED strip attached to a portion of the body.
